(19) United States
(12) Patent Application Publication
(10) Pub. No.: US 2021/0094003 A1
(43) Pub. Date: Apr. 1, 2021

(54) MEMBRANES WITH REDUCED PARTICLE FORMATION

(71) Applicant: ENTEGRIS, INC., Billerica, MA (US)

(72) Inventor: Sina BONYADI, Billerica, MA (US)

(21) Appl. No.: 17/027,082

(22) Filed: Sep. 21, 2020

Related U.S. Application Data
(60) Provisional application No. 62/908,733, filed on Oct. 1, 2019.

(51) Int. Cl. B01D 69/02; B01D 71/68; B01D 67/00; B01D 65/10

(52) U.S. Cl. CPC B01D 69/02; B01D 71/68; B01D 2323/08; B01D 65/10; B01D 2325/022; B01D 67/0013

(57) ABSTRACT

Disclosed herein are membranes having a first surface, a second surface opposing the first surface, a skin at the first surface having visible pores when viewed at a magnification of 10,000 and a pore size gradient, wherein pore size increases from the second surface to the skin.

### CROSS-REFERENCE TO RELATED APPLICATIONS

This application claims the benefit under 35 USC 119 of U.S. Provisional Patent Application No. 62/908,733, filed Oct. 1, 2019, the disclosure of which is hereby incorporated herein by reference in its entirety.

### TECHNICAL FIELD

The present disclosure generally relates to membranes with reduced particle formation on the surface facing a support during formation.

### BACKGROUND

The semiconductor industry relies on wet etch and clean processes to produce wafers. The liquids used in the wet etch and clean processes are filtered to remove microcontaminants from the liquids. In some embodiments, these wet etch and clean applications need filters having membranes that can deliver a minimum flow rate of 10 liters/min of filtered media. Such high flow rates require a minimum flux in a range of 2,000 LMH/bar ((liters/meter²/hour)/bar). Suitable membranes meeting the flow rate and flux requirements include immersion cast polymeric membranes, for example polysulfone-type membranes. However, the immersion casting process can lead to the formation of particles or beads on the open side of the membrane. The particles are not always removed during cleaning of the membrane/filter and the particles can shed during use of the filter incorporating the membranes, thereby reducing the effectiveness of the filter. A need exists for membranes with reduced particle formation and accordingly possibly reduced particle shedding.

### SUMMARY

In a first aspect, a membrane comprises: a first surface; a second surface opposing the first surface; a skin at the first surface having visible pores when viewed at a magnification of 10,000; and a pore size gradient, wherein pore size increases from the second surface to the skin.

A second aspect according to the first aspect, wherein the membrane is selected from the group consisting of polysulfone, polyethersulfone, polyphenylsulfone, polyarylsulfone, polyimide, polyamide-imide, and polyvinylidene fluoride.

A third aspect according to any of the preceding aspects, wherein the membrane has a skin at the second surface having no visible pores when viewed at a magnification of 10,000.

A fourth aspect according to any of the preceding aspects, wherein the membrane has a mean bubble point in a range from about 40 psi to about 75 psi as measured according to test method B of ASTM F316-03 (2011) using ethoxy-nonafluorobutane (HFE-7200) as the wetting fluid and having the wetting fluid flow from the first surface to the second surface.

A fifth aspect according to any of the preceding aspects, wherein the membrane has a mean bubble point in a range from about 75 psi to about 150 psi as measured according to test method B of ASTM F316-03 (2011) using ethoxy-nonafluorobutane (HFE-7200) as the wetting fluid and having the wetting fluid flow from the second surface to the first surface.

A sixth aspect according to any of the preceding aspects, wherein a thickness of the membrane is in a range from about 40 microns to about 150 microns.

A seventh aspect according to any of the preceding aspects, wherein a thickness of the skin at the first surface is in a range from greater than 0 to about 2 microns.

An eighth aspect according to any of the preceding aspects, wherein the skin at the first surface has a porosity of about 15% or less.

A ninth aspect according to any of the preceding aspects, wherein the second surface has a porosity in a range from about 10% to about 60%.

A tenth aspect according to any of the preceding aspects, wherein the second surface has a greater porosity than the skin at the first surface.

In an eleventh aspect, a filter comprises the membrane of any of the preceding aspects.

A twelfth aspect according to the eleventh aspect, wherein the membrane sheds less than 300 particles at the 60 minute mark when the filter is subjected to The Particle Shedding Test.

A thirteenth aspect according to the eleventh aspect, wherein the membrane sheds less than 200 particles at the 60 minute mark when the filter is subjected to The Particle Shedding Test.

A fourteenth aspect according to the eleventh aspect, wherein the membrane sheds less than 100 particles at the 60 minute mark when the filter is subjected to The Particle Shedding Test.

In a fifteenth aspect, a method of forming a membrane comprises: casting a polymer solution on a hydrophilic support to form a membrane, wherein the membrane comprises: a first surface; a second surface contacting the hydrophilic support and opposing the first surface; a skin at the first surface having visible pores when viewed at a magnification of 10,000; and a pore size gradient, wherein a pore size increases from the second surface to the skin.

A sixteenth aspect according to the fifteenth aspect, wherein the hydrophilic support is a polyester.

A seventeenth aspect according to the sixteenth aspect, wherein the hydrophilic support is a biaxially-oriented polyethylene terephthalate.

An eighteenth aspect according to any of the fifteenth through seventeenth aspects, further comprising immersing the hydrophilic support with the polymer solution thereon in a water bath.

A nineteenth aspect according to the eighteenth aspect, wherein the water bath has a temperature in a range from about 0° C. to about 40° C.

A twentieth aspect according to any of the fifteenth through nineteenth aspects, wherein the membrane has a polymer content in a range from about 10 wt % to about 30 wt %.

A twenty-first aspect according to the twentieth aspect, wherein the membrane has a polymer content in a range from about 10 wt % to about 15 wt %.

A twenty-second aspect according to the twentieth aspect, wherein the membrane has a polymer content in a range from about 15 wt % to about 30 wt %.

A twenty-third aspect according to any of the fifteenth through twenty-second aspects, wherein the polymer solution comprises a polymer, a solvent, and a non-solvent.

### BRIEF DESCRIPTION OF THE DRAWINGS

The disclosure may be more completely understood in consideration of the following description of various illustrative embodiments in connection with the accompanying drawings.

FIG. 1 is an exemplary cross-sectional view of a membrane disclosed herein taken with a SEM (scanning electron microscope) at a magnification of 2,500;

FIG. 2 is a picture of the open side surface of a membrane taken with a SEM at a magnification of 5,000;

FIG. 3A is a picture of the open side surface of an exemplary membrane in Example 2 with the skin taken with a SEM at a magnification of 10,000;

FIG. 3B is a cross-sectional picture of the open side of an exemplary membrane in Example 2 showing the skin taken with a SEM at a magnification of 10,000;

FIG. 3C is a picture of the tight side surface of an exemplary membrane in Example 2 taken with a SEM at a magnification of 10,000;

FIG. 3D is a cross-sectional picture of the tight side of an exemplary membrane in Example 2 taken with a SEM at a magnification of 10,000;

FIG. 4A is a picture of the open side surface of an exemplary membrane in Example 3 with the skin taken with a SEM at a magnification of 10,000;

FIG. 4B is a cross-sectional picture of the open side of an exemplary membrane in Example 3 showing the skin taken with a SEM at a magnification of 10,000;

FIG. 4C is a picture of the tight side surface of an exemplary membrane in Example 3 taken with a SEM at a magnification of 10,000;

FIG. 4D is a cross-sectional picture of the tight side of an exemplary membrane in Example 3 taken with a SEM at a magnification of 10,000;

FIG. 5 is a plot showing the number of particles shed on the y axis and the time in minutes on the x axis for the membranes tested in Example 4;

FIG. 6A is a picture of the open side surface of the membrane having a skin from Example 5 taken with a SEM at a magnification of 5,000; and

FIG. 6B is a picture of the open side surface of the membrane having a skin from Example 2 taken with a SEM at a magnification of 5,000.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g. 1 to 5 includes 1, 1.5, 2, 2.75, 3, 3.80, 4 and 5).

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

Disclosed herein are membranes having a first surface and a second surface opposing the first surface. The membranes also having a pore size gradient in the membrane cross-section wherein pores in the membrane increase in size form the second surface up to a skin formed at the first surface. The second surface having the pores with the smaller pore size is referred to herein as the “tight side”. The first surface having the skin covering the pores that are larger in size is referred to herein as the “open side”. The skin at the open side, also referred to herein as an “imperfect” skin” is a portion of the membrane having relatively fewer pores than the adjacent portion of the membrane, while still having some pores that are viewable at 10,000 magnification under a scanning electron microscope (SEM). It is believed that the presence of the skin on the open side of the membrane reduces the formation of particles on the membrane open side and leads to potentially lower amount of particle shedding from the membrane during use.

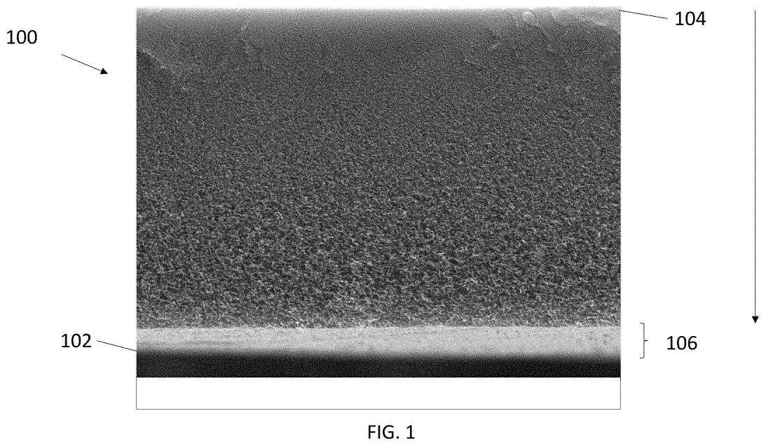

FIG. 1 shows a cross-sectional view of an exemplary membrane 100 having a first surface 102 and a second surface 104 opposing first surface 102. A skin 106 is formed at first surface 102. There are pores throughout the thickness of membrane 100. In some embodiments, there is a pore size gradient in the membrane cross-section wherein the pores grow in size from second surface 104 toward skin 106 as designated by the arrow in FIG. 1. Membranes with a pore size gradient are also referred to as asymmetric. First surface 102 is the open side and second surface 104 is the tight side. Skin 106 is an imperfect skin in that there are pores viewable at a magnification of 10,000 with a SEM. In some embodiments, a skin may be formed at the second surface that is a “perfect” skin, meaning that there are no pores visible at a magnification of 10,000 with a SEM. In some embodiments, the second surface may have a skin with pores that are less than 1 micron in size when viewed with a SEM at a magnification of 10,000.

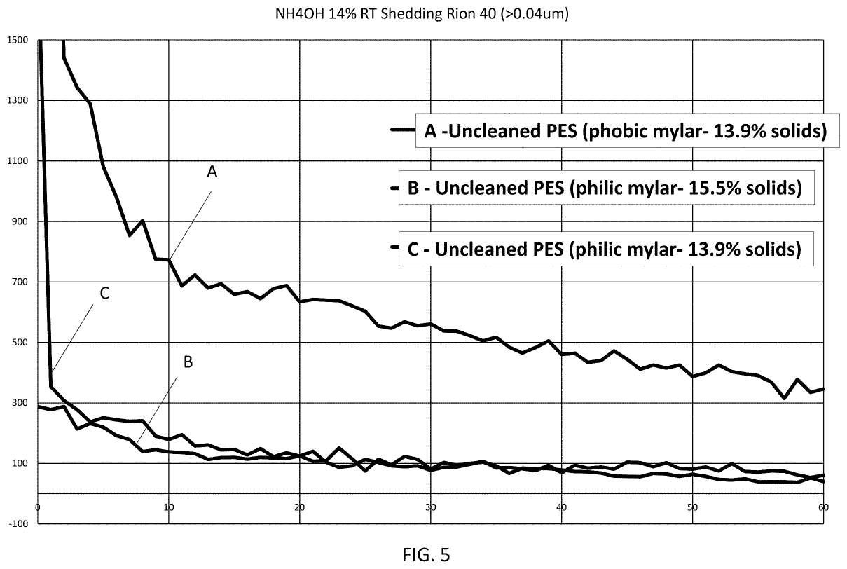

In some embodiments, membrane 100 is polymeric. In some embodiments, the polymer used for the membrane includes, but is not limited to, polysulfone, polyethersulfone, polyphenylsulfone, polyarylsulfone, polyimide, polyamide-imide, and polyvinylidene fluoride. In some embodiments, membrane 100 is made from a solution that has a polymer content of in a range from about 10 wt % to about 30 wt %, about 10 wt % to about 27 wt %, about 10 wt % to about 25 wt %, about 10 wt % to about 20 wt %, about 10 wt % to about 15 wt %, about 12 wt % to about 30 wt %, about 12 wt % to about 27 wt %, about 12 wt % to about 25 wt %, about 12 wt % to about 20 wt %, about 12 wt % to about 15 wt %, about 15 wt % to about 30 wt %, about 15 wt % to about 27 wt %, about 15 wt % to about 25 wt %, about 15 wt % to about 20 wt %, about 20 wt % to about 30 wt %, about 20 wt % to about 27 wt %, about 20 wt % to about 25 wt %, about 25 wt % to about 30 wt %, or about 25 wt % to about 27 wt %, and all ranges and subranges therein. As discussed below in Example 4 and with reference to FIG. 5, it is believed that increasing the amount of polymer in the membrane decreases the amount of particle formation on the open side of the membrane.

In some embodiments, open side skin 106 has a thickness in a range from greater than 0 to about 2 microns, from greater than 0 to about 1.5 microns, from greater than 0 to about 1 micron, from about 0.5 micron to about 2 microns, from about 0.5 micron to about 1.5 microns, from about 1 micron to about 2 microns, from about 1 micron to about 1.5 microns, and all ranges and subranges therein. In some embodiments, membrane 100 has a thickness in a range from about 40 microns to about 150 microns, about 40 microns to about 125 microns, about 40 microns to about 100 microns, about 60 microns to about 150 microns, about 60 microns to about 125 microns, about 60 microns to about 100 microns, about 75 microns to about 150 microns, about 75 microns to about 125 microns, or about 75 micron to about 100 microns.

In some embodiments, open side skin 106 has porosity of about 15% or less, about 10% or less, or about 5% or less, as estimated when viewing the surface of the open side skin under a SEM at a magnification of 10,000. In some embodiments, second surface 104 has a porosity of from about 10% to about 60%, about 10% to about 50%, about 10% to about 40%, about 15% to about 60%, about 15% to about 50%, about 15% to about 40%, about 20% to about 60%, about 20% to about 50%, about 20% to about 40%, as estimated when viewing the surface of second surface 104 under a SEM at a magnification of 10,000. In some embodiments, second surface 104 has a greater porosity than open side skin 106, as estimated by viewing the surfaces under a SEM at a magnification of 10,000.

The mean bubble point (also referred to as the mean flow pore pressure) of the membranes may be measured according to ASTM F316-03 (2011) titled, Standard Test Methods for Pore Size Characteristics of Membrane Filters by Bubble Point and Mean Flow Pore Test using test method B modified to use ethoxy-nonafluorobutane (HFE-7200) available from 3M as the wetting fluid. In some embodiments, the membranes have a mean bubble point in a range from about 40 psi to about 75 psi when measured with the wetting fluid flowing from the open-side to the tight-side. In some embodiments, the membranes have a mean bubble point in a range from about 75 psi to about 150 psi when measured with the wetting fluid flowing from the tight-side to the open-side.

In some embodiments, the membranes disclosed herein are made by an immersion casting process. The process includes creating a solution containing the polymer, one or more solvents, and one or more non-solvents. As noted above the polymer for the membrane includes, but is not limited to, polysulfone, polyethersulfone, polyphenylsulfone, polyarylsulfone, polyimide, and polyamide-imide.

In some embodiments, the solution has a polymer content in a range from about 10 wt % to about 30 wt %, about 10 wt % to about 27 wt %, about 10 wt % to about 25 wt %, about 10 wt % to about 20 wt %, about 10 wt % to about 15 wt %, about 12 wt % to about 30 wt %, about 12 wt % to about 27 wt %, about 12 wt % to about 25 wt %, about 12 wt % to about 20 wt %, about 12 wt % to about 15 wt %, about 15 wt % to about 30 wt %, about 15 wt % to about 27 wt %, about 15 wt % to about 25 wt %, about 15 wt % to about 20 wt %, about 20 wt % to about 30 wt %, about 20 wt % to about 27 wt %, about 20 wt % to about 25 wt %, about 25 wt % to about 30 wt %, or about 25 wt % to about 27 wt %, and all ranges and subranges therein.

In some embodiments, the solution has a solvent content in a range from about 20 wt % to about 90 wt %, about 20 wt % to about 80 wt %, about 20 wt % to about 70 wt %, about 20 wt % to about 60 wt %, about 20 wt % to about 50 wt %, about 20 wt % to about 40 wt %, about 30 wt % to about 90 wt %, about 30 wt % to about 80 wt %, about 30 wt % to about 70 wt %, about 30 wt % to about 60 wt %, about 30 wt % to about 50 wt %, about 40 wt % to about 90 wt %, about 40 wt % to about 80 wt %, about 40 wt % to about 70 wt %, about 40 wt % to about 60 wt %, about 50 wt % to about 90 wt %, about 50 wt % to about 80 wt %, about 50 wt % to about 70 wt %, about 60 wt % to about 90 wt %, about 60 wt % to about 80 wt %, about 70 wt % to about 90 wt %, and all ranges and subranges therein. Suitable solvents include, but are not limited to, dimethylformamide, dimethylacetamide, dioxane, n-methyl pyrrolidone, dimethylsulfoxide, chloroform, tetramethylurea, tetrachloroethane, and mixtures thereof.

In some embodiments, the solution has a non-solvent content in a range 0 wt % to about 70 wt %, about 0 wt % to about 60 wt %, 0 wt % to about 50 wt %, 0 wt % to about 40 wt %, 0 wt % to about 30 wt %, 0 wt % to about 20 wt %, about 10 wt % to about 70 wt %, about 10 wt % to about 60 wt %, about 10 wt % to about 50 wt %, about 10 wt % to about 40 wt %, about 10 wt % to about 30 wt %, about 20 wt % to about 70 wt %, about 20 wt % to about 60 wt %, about 20 wt % to about 50 wt %, about 20 wt % to about 40 wt %, about 20 wt % to about 30 wt %, about 40 wt % to about 70 wt %, about 40 wt % to about 60 wt %, about 50 wt % to about 70 wt %, about 60 wt % to about 70 wt %, and all ranges and subranges therein. Suitable non-solvents include, but are not limited to, alcohols (for example, methanol, ethanol, isopropanol, amyl alcohol, hexanol, heptanol, octanol, ethylene glycol, or triethylene glycol), alkanes (for example, propane, hexane, heptane, or octane), ketones (for example, acetone, methylethylketone, or methylisobutylketone) nitropropane, ethers (for example, butyl ether, propylene glycol methyl ether (PGME), or tripropylene glycol methyl ether (TPM)), ethyl acetate, amyl acetate, water, acids (for example, propionic acid, or bases and mixtures thereof.

The process also includes casting the solution on a moving belt or rotating drum covered with a hydrophilic support film and immersing the cast solution in a water bath to form the membrane. In some embodiments, the hydrophilic film is a polyester film for example a biaxially-oriented polyethylene terephthalate film such as Mylar®. In some embodiments, the hydrophilic film may be a polyester film, for example a biaxially-oriented polyethylene terephthalate film, having a hydrophilic coating on one or both surfaces, such as Melinex® 462. In some embodiments, the water bath is maintained at a temperature in a range from about 0° C. to about 40° C., about 0° C. to about 35° C., about 0° C. to about 30° C., about 0° C. to about 25° C., about 0° C. to about 20° C., about 0° C. to about 15° C., about 0° C. to about 10° C., about 5° C. to about 40° C., about 5° C. to about 35° C., about 5° C. to about 30° C., about 5° C. to about 25° C., about 5° C. to about 20° C., about 5° C. to about 15° C., about 5° C. to about 10° C., about 10° C. to about 40° C., about 10° C. to about 35° C., about 10° C. to about 30° C., about 10° C. to about 25° C., about 10° C. to about 20° C., about 10° C. to about 15° C., about 15° C. to about 40° C., about 15° C. to about 35° C., about 15° C. to about 30° C., about 15° C. to about 25° C., about 15° C. to about 20° C., about 20° C. to about 40° C., about 20° C. to about 35° C., about 20° C. to about 30° C., about 20° C. to about 25° C., about 25° C. to about 40° C., about 25° C. to about 35° C., about 25° C. to about 30° C., and any ranges or subranges therein. As discussed below in Example 5, it is believed that as the temperature of the water bath is reduced, the pore size in the skin will be smaller, and the amount of particle formation on the open side of the membrane will be reduced.

The methods disclosed herein resulted in fewer particles on open side as a result of the imperfect open side skin, which is believed to lead to less particle shedding.

The membranes disclosed herein can have any convenient geometric configuration including, but not limited to, a flat sheet, a corrugated sheet, or a hollow fiber. In some embodiments, the membranes disclosed herein are incorporated into a filter by placing the membrane inside a filter housing.

### EXAMPLES

### Example 1

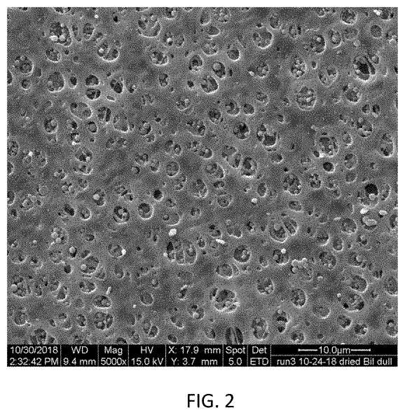

A polyethersulfone membrane was formed by creating a solution having 13.9 weight % polyethersulfone, 45.5 wt % of n-methyl pyrrolidone, and 40.6 wt % of propionic acid. The solution was cast on a moving belt covered with a hydrophobic film Mylar® A. The solution was passed through an immersion water bath having a temperature of about 25° C. The membrane formed was asymmetric and had a tight-side facing away from the hydrophobic Mylar® A film and an open side contacting the hydrophobic Mylar® A film. FIG. 2 is a picture of the open side surface of the membrane taken with a SEM (scanning electron microscope) at a magnification of 5,000.

### Example 2

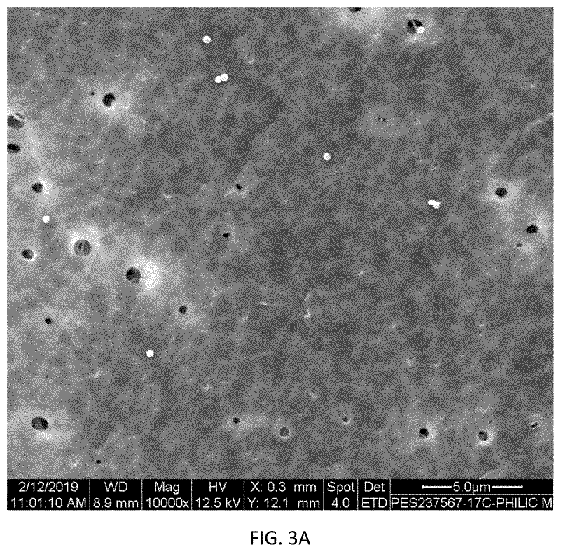

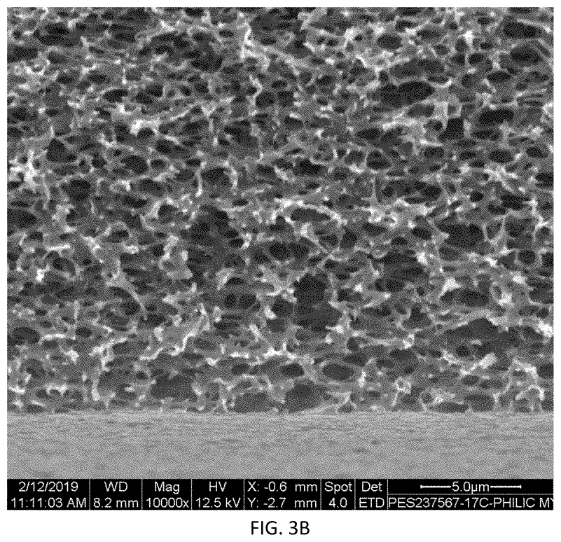

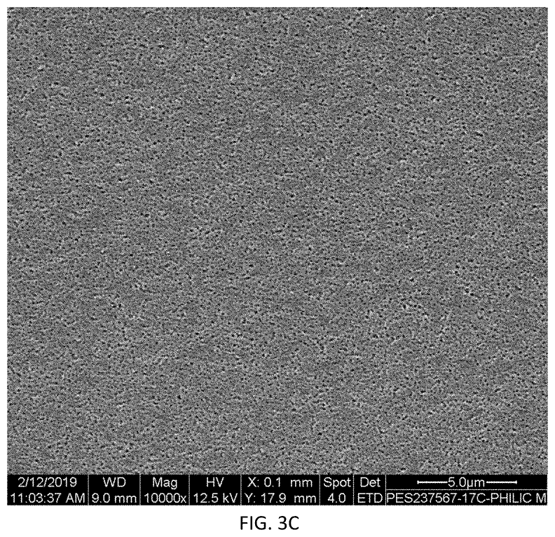

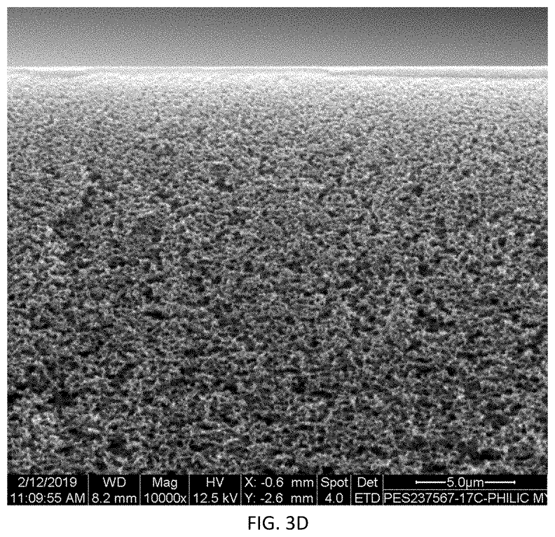

A polyethersulfone membrane was formed using the same process as in Example 1 except that the solution was cast on a moving belt covered with a hydrophilic Melinex® 462 film. The membrane formed was asymmetric and had a tight side facing away from the hydrophilic film and an open side contacting the hydrophilic film. Unexpectedly the open side of the membrane had an imperfect skin having a thickness of approximately 0.5 microns. FIG. 3A is a picture of the open side surface of the membrane having a skin taken with a SEM at a magnification of 10,000. As can be seen, the skin has pores on the surface. FIG. 3B is a cross-sectional picture of the open side of the membrane showing the skin taken with a SEM at a magnification of 10,000. The skin is shown at the bottom of the picture. FIG. 3C is a picture of the tight side surface of the membrane taken with a SEM at a magnification of 10,000. FIG. 3D is a cross-sectional picture of the tight side of the membrane taken with a SEM at a magnification of 10,000.

### Example 3

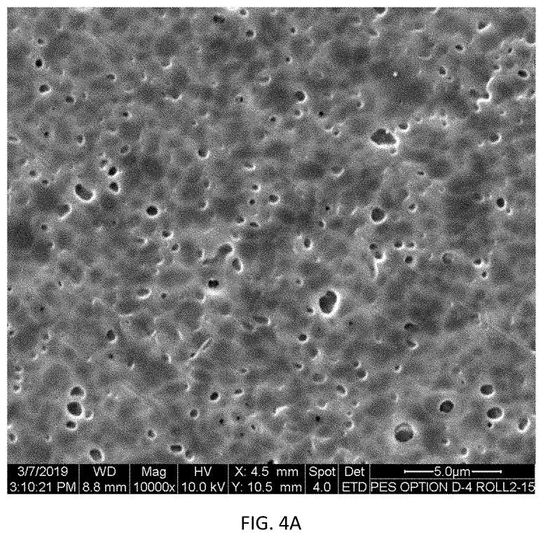

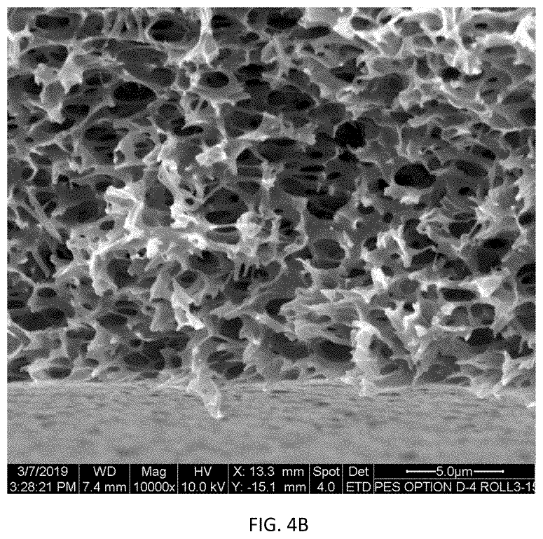

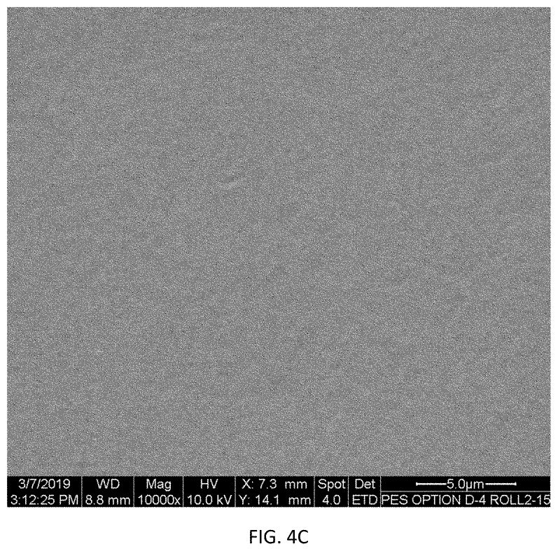

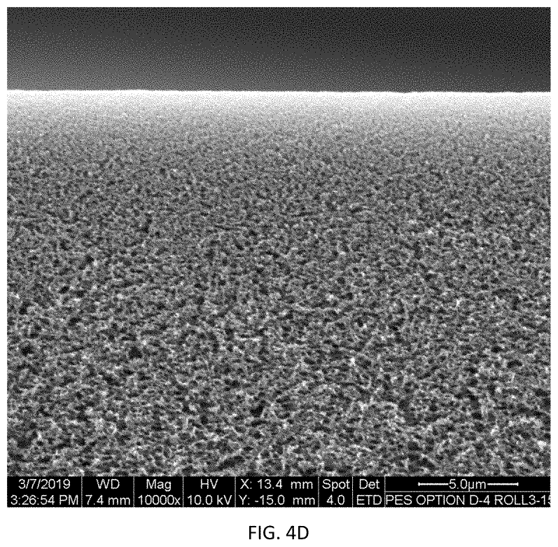

A polyethersulfone membrane was formed using the same process as in Example 2 except that the solution was cast on a rotating drum covered with a hydrophilic Melinex® 462 film was 15.5 weight % polyethersulfone, 44.4 wt % of n-methyl pyrrolidone, and 40.1 wt % of propionic acid. The membrane formed was asymmetric and had a tight-side facing away from the hydrophilic film and an open-side contacting the hydrophilic film. Unexpectedly the open side of the membrane had a skin having a thickness of approximately 0.5 microns. As shown in FIG. 4A, which is a picture of the open side surface of the membrane with the skin taken with a SEM at a magnification of 10,000. As can be seen, the skin has pores on the surface. FIG. 4B is a cross-sectional picture of the open side of the membrane showing the skin taken with a SEM at a magnification of 10,000. The skin is shown at the bottom of the picture. FIG. 4C is a picture of the tight side surface of the membrane taken with a SEM at a magnification of 10,000. FIG. 4D is a cross-sectional picture of the tight-side of the membrane taken with a SEM at a magnification of 10,000.

### Example 4

Membranes from examples 1-3 were subjected to a particle shedding test using a KS-18FX (40 nm) Rion particle counter wherein the particles shed were counted for 60 minutes. The results are shown in FIG. 5 with the time elapsed (in minutes) on the x axis and the number of particles shed on the y axis. The data shows there is reduced particle shedding when using a hydrophilic film instead of a hydrophobic film. The data also shows that the membrane from Example 3, which had 15.5 wt % polymer, had less particle shedding than the membrane from Example 2, which had 13.9 wt % polymer, indicates that an increase in the polymer concentration in the membrane appears to result in lowering the amount of particle shedding.

The procedure for The Particle Shedding Test includes placing the membrane in a filter. Ammonium hydroxide (NH₄OH) was passed through a guard filter and then a test filter and then a KS-18FX (40 nm) Rion particle counter. The ammonium hydroxide was allowed to flow through the particle counter until there were no more visible bubbles in the sample line and then the flow through the particle counters was reduced to a range between 10-20 cc/min. The flow rate through the test filter was approximately 3 liters per minute. The particle counters counted the particles that shed off the membrane in the test filter for 60 minutes. Thus, in some embodiments, a filter including the membranes disclosed herein, are subjected to The Particle Shedding Test, the membrane may shed less than 300 particles at the 60 minute mark, less than 200 particles at the 60 minute mark, or less than 100 particles.

### Example 5

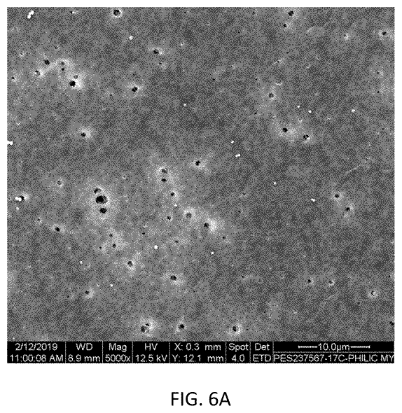

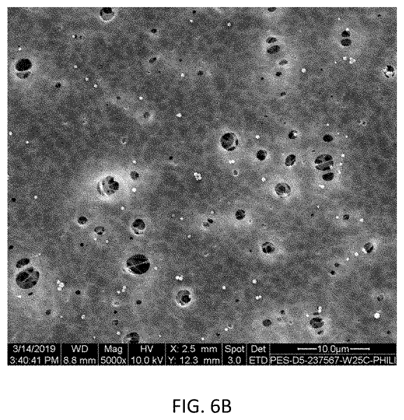

A polyethersulfone membrane was formed using the same procedure outlined in Example 2 except the water bath had a temperature of 17° C. FIG. 6A is a picture of the open side surface of the membrane having a skin taken with a SEM (scanning electron microscope) at a magnification of 5,000. In comparison FIG. 6B is a picture of the open side surface of the membrane having a skin from Example 2 taken with a SEM at a magnification of 5,000. As can be seen by comparing the pictures, the membrane made using a water bath with a lower temperature had smaller pores in the open side skin.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. Changes may be made in details, particularly in matters of shape, size, and arrangement of parts without exceeding the scope of the disclosure. The disclosure's scope is, of course, defined in the language in which the appended claims are expressed.

What is claimed is:

1. A membrane comprising:
a first surface;
a second surface opposing the first surface;
a skin at the first surface having visible pores when viewed at a magnification of 10,000; and
a pore size gradient, wherein pore size increases from the second surface to the skin.

2. The membrane of claim 1, wherein the membrane is selected from the group consisting of polysulfone, polyethersulfone, polyphenylsulfone, polyarylsulfone, polyimide, polyamide-imide, and polyvinylidene fluoride.

3. The membrane of claim 1, wherein the membrane has a skin at the second surface having no visible pores when viewed at a magnification of 10,000.

4. The membrane of claim 1, wherein the membrane has a mean bubble point in a range from about 40 psi to about 75 psi as measured according to test method B of ASTM F316-03 (2011) using ethoxy-nonafluorobutane (HFE-7200) as the wetting fluid and having the wetting fluid flow from the first surface to the second surface.

5. The membrane of claim 1, wherein the membrane has a mean bubble point in a range from about 75 psi to about 150 psi as measured according to test method B of ASTM F316-03 (2011) using ethoxy-nonafluorobutane (HFE-7200) as the wetting fluid and having the wetting fluid flow from the second surface to the first surface.

6. The membrane of claim 1, wherein a thickness of the membrane is in a range from about 40 microns to about 150 microns.

7. The membrane of claim 1, wherein a thickness of the skin at the first surface is in a range from greater than 0 to about 2 microns.

8. The membrane of claim 1, wherein the skin at the first surface has a porosity of about 15% or less.

9. The membrane of claim 1, wherein the second surface has a porosity in a range from about 10% to about 60%.

10. The membrane of claim 1, wherein the second surface has a greater porosity than the skin at the first surface.

11. A filter comprising the membrane of claim 1.

12. The filter of claim 11, wherein the membrane sheds less than 300 particles at the 60 minute mark when the filter is subjected to The Particle Shedding Test.

13. The filter of claim 11, wherein the membrane sheds less than 200 particles at the 60 minute mark when the filter is subjected to The Particle Shedding Test.

14. The filter of claim 11, wherein the membrane sheds less than 100 particles at the 60 minute mark when the filter is subjected to The Particle Shedding Test.

15. A method of forming a membrane comprising:
casting a polymer solution on a hydrophilic support to form a membrane, wherein the membrane comprises:
a first surface;
a second surface contacting the hydrophilic support and opposing the first surface;
a skin at the first surface having visible pores when viewed at a magnification of 10,000; and
a pore size gradient, wherein a pore size increases from the second surface to the skin.

16. The method of claim 15, wherein the hydrophilic support is a polyester.

17. The method of claim 16, wherein the hydrophilic support is a biaxially-oriented polyethylene terephthalate.

18. The method of claim 15, further comprising immersing the hydrophilic support with the polymer solution thereon in a water bath.

19. The method of claim 18, wherein the water bath has a temperature in a range from about 0° C. to about 40° C.

20. The method of claim 15, wherein the membrane has a polymer content in a range from about 10 wt % to about 30 wt %.
